(19) United States
(12) Patent Application Publication
(10) Pub. No.: US 2025/0053947 A1
(43) Pub. Date: Feb. 13, 2025

(54) PAYMENT TERMINAL AND PAYMENT ASSISTANCE METHOD

(71) Applicant: PANASONIC INTELLECTUAL PROPERTY MANAGEMENT CO., LTD., Osaka (JP)

(72) Inventors: Takuto NAITO, Kanagawa (JP); Yasuhiro SHIBATA, Kanagawa (JP); Yuki INABE, Kanagawa (JP); Hiroki MORIIZUMI, Kanagawa (JP)

(73) Assignee: PANASONIC INTELLECTUAL PROPERTY MANAGEMENT CO., LTD., Osaka (JP)

(21) Appl. No.: 18/929,163

(22) Filed: Oct. 28, 2024

Related U.S. Application Data
(63) Continuation of application No. PCT/JP2023/037943, filed on Oct. 19, 2023.

(30) Foreign Application Priority Data
Dec. 12, 2022 (JP) 2022-198008

(51) Int. Cl. G06Q 20/20; G06F 3/14; G06Q 20/38; H04N 19/30; H04N 23/63

(52) U.S. Cl. CPC G06Q 20/208; G06F 3/1423; G06Q 20/385; H04N 19/30; H04N 23/63

(57) ABSTRACT

A payment terminal capable of performing payment using a code includes a first display unit; a second display unit; an imaging unit arranged near the first display unit and configured to capture an image of the code displayed on a medium; and a control unit configured to control the first display unit, the second display unit, and the imaging unit. The control unit acquires a captured image captured by the imaging unit, and causes a first preview image based on the captured image to be displayed on the first display unit while simultaneously causing a second preview image based on the captured image to be displayed on the second display unit.

### CROSS-REFERENCE TO RELATED APPLICATIONS

This is a continuation of International Application No. PCT/JP2022/037943 filed on Oct. 19, 2023, and claims priority from Japanese Patent Application No. 2022-198008 filed on Dec. 12, 2022, the entire contents of which are incorporated herein by reference.

### TECHNICAL FIELD

The present disclosure relates to a payment terminal and a payment assistance method.

### BACKGROUND ART

In the related art, an automatic transaction device is known that includes, on a front operation panel, a customer operation display panel for displaying a screen guiding a customer operation, and receiving the customer operation, and performs transaction according to information input by the customer operation. The automatic transaction device includes an optical information reading unit that is arranged above the front operation panel and reads a business form placed on the front operation panel and a barcode displayed on a reading object such as a mobile terminal. The automatic transaction device displays a position in which the business form and a mobile phone or a barcode thereof should be aligned with the screen (see Patent Literature 1).

### CITATION LIST

### Patent Literature

Patent Literature 1: JP2007-164367A

### SUMMARY OF INVENTION

According to the technique of Patent Literature 1, a customer can grasp a preferable position of the barcode and the like with respect to the screen, but it is difficult to actually align the barcode with the position. For example, it may be difficult to appropriately maintain the position and a distance of the barcode with respect to the screen, it may be difficult to appropriately adjust the distance of the barcode with respect to the screen to a focal length of a camera that captures an image of the barcode, and it may be difficult to adjust the position of the barcode to an appropriate range in an imaging range of the camera.

The present disclosure provides a payment terminal and a payment assistance method that are capable of easily guiding a position of a medium with respect to a camera that captures an image of a code displayed on the medium.

One aspect of the present disclosure relates to a payment terminal capable of performing payment using a code, the payment terminal includes a first display unit; a second display unit; an imaging unit arranged near the first display unit and configured to capture an image of the code displayed on a medium; and a control unit configured to control the first display unit, the second display unit, and the imaging unit, in which the control unit acquires a captured image captured by the imaging unit, and causes a first preview image based on the captured image to be displayed on the first display unit while simultaneously causing a second preview image based on the captured image to be displayed on the second display unit.

One aspect of the present disclosure relates to a payment assistance method for assisting payment using a code provided by a payment terminal, the payment terminal includes a first display unit, a second display unit, and an imaging unit that is arranged near the first display unit and captures an image of the code displayed on a medium. The payment assistance method includes acquiring a captured image captured by the imaging unit; and displaying, on the first display unit, a first preview image based on the captured image while simultaneously displaying, on the second display unit, a second preview image based on the captured image.

According to the present disclosure, the position of the medium can be easily guided with respect to the camera that captures an image of the code displayed on the medium.

### BRIEF DESCRIPTION OF DRAWINGS

FIG. 1A is a top view showing an appearance example of a payment terminal according to a first embodiment;

FIG. 1B is a side view showing the appearance example of the payment terminal;

FIG. 1C is a front view showing the appearance example of the payment terminal;

FIG. 2 is a block diagram showing an electrical configuration example of the payment terminal according to the first embodiment;

FIG. 3 is a diagram showing an example of a mobile terminal on which a code is displayed;

FIG. 4 is a flowchart showing an operation example of the payment terminal;

FIG. 5 is a diagram showing a transition example of screen display during a payment process performed by the payment terminal;

FIG. 6 is a diagram showing a first example of a screen on which an image including a preview image for a customer is displayed;

FIG. 7 is a diagram showing a second example of the screen on which the image including the preview image for the customer is displayed;

FIG. 8 is a diagram showing a third example of the screen on which the image including the preview image for the customer is displayed;

FIG. 9 is a diagram showing an example of a screen on which a preview image for a shop assistant is displayed;

FIG. 10 is a schematic diagram showing an appearance example of a payment terminal according to a second embodiment;

FIG. 11 is a front perspective view showing an appearance example of a customer terminal;

FIG. 12 is a schematic cross-sectional view showing an example of the customer terminal in transparency as viewed from a side surface; and

FIG. 13 is a block diagram showing an electrical configuration example of the payment terminal according to the second embodiment.

### DESCRIPTION OF EMBODIMENTS

Hereinafter, embodiments will be described in detail with reference to the drawings as appropriate. However, the unnecessarily detailed description may be omitted. For example, the detailed descriptions of well-known matters and the redundant description of substantially the same configuration may be omitted. This is to avoid unnecessary redundancy of the following description and to facilitate understanding of those skilled in the art. It should be noted that the accompanying drawings and the following description are provided for those skilled in the art to fully understand the present disclosure, and are not intended to limit the subject matter described in the claims.

### First Embodiment

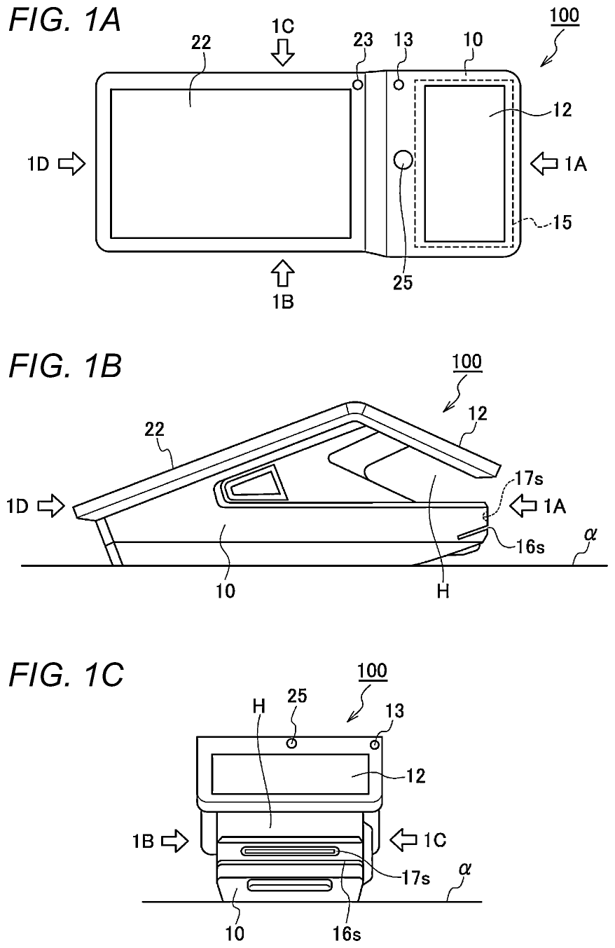

FIG. 1A is a top view showing an appearance example of a payment terminal 100 according to a first embodiment. FIG. 1B is a side view showing the appearance example of the payment terminal 100. FIG. 1C is a front view showing the appearance example of the payment terminal 100.

The payment terminal 100 includes a main body 10. The main body 10 has, for example, a general box shape. FIGS. 1A, 1B, and 1C show a front surface 1A, a side surface 1B, a side surface 1C, and a rear surface 1D of the payment terminal 100. For example, a purchaser (a customer) of a product operates the payment terminal 100 from a front surface 1A side. For example, a shop assistant or the like of a store who registers the purchase of the product operates the payment terminal 100 from a rear surface 1D side. The customer may be a customer of the store. The payment terminal 100 is a stationary terminal placed on a placement table or the like of the store.

The payment terminal 100 includes, on the front surface 1A side, a first touch panel 12, a first light emitting diode (LED) 13, a near field communication (NFC) antenna 15, a first card slot 16s, a second card slot 17s, and a camera 25. The payment terminal 100 includes a second touch panel 22 and a second LED 23 on the rear surface 1D side.

The payment terminal 100 is a complex type that allows the customer to select a plurality of payment methods. The payment terminal 100 may be used, for example, in a state of being placed on a placement surface α on a counter of the store.

The plurality of payment methods include, for example, credit card payment, electronic money payment, code (for example, QR code (registered trademark)) payment, and cash payment. The credit card payment includes, for example, magnetic card payment, contact IC card payment, and non-contact IC card payment. The electronic money may include a plurality of types of electronic money. Since the electronic money payment and the non-contact IC card payment are executed using a non-contact communication (for example, a near field communication (NFC)), the electronic money payment and the non-contact IC card payment are collectively referred to as non-contact payment here.

The plurality of payment methods are executed using a plurality of corresponding payment interfaces. The plurality of payment interfaces include, for example, a credit card, an electronic money card C32, a code, and cash. The credit card includes, for example, a magnetic card C1, a contact IC card C2, and a non-contact IC credit card C31.

The magnetic card C1 is inserted into the first card slot 16s and is used for payment. The contact IC card C2 is inserted into the second card slot 17s and is used for payment. The non-contact IC credit card C31 and the electronic money card C32 are brought close to the NFC antenna 15 and are used for payment. The non-contact IC credit card C31 and the electronic money card C32 are collectively referred to as a “non-contact IC card C3”.

In the payment terminal 100, the first card slot 16s, the second card slot 17s, and the first touch panel 12 are arranged in order from proximity with the placement surface α in a height direction from the placement surface α. The NFC antenna 15 is arranged around the first touch panel 12.

Further, in the payment terminal 100, the first card slot 16s, the second card slot 17s, the first touch panel 12, and the NFC antenna 15 are collectively arranged on the front surface 1A side facing the customer. In this case, the customer can easily select any payment method among a plurality of payment methods corresponding to a plurality of devices arranged in front of the customer's eye. Since the plurality of devices corresponding to the plurality of payment methods are collected in one place, the payment according to each payment method can be smoothly executed.

Further, the second touch panel 22 is arranged in the payment terminal 100. For example, the second touch panel 22 is used by the shop assistant and is arranged on the rear surface 1D side facing the shop assistant. In the payment terminal 100, the first touch panel 12 and the second touch panel 22 are arranged opposite to each other.

In addition, an upper side of the payment terminal 100 has a chevron shape when the payment terminal 100 is viewed from a side surface (see FIG. 1B). The chevron shape includes a first surface and a second surface. The first surface is a surface including a surface of the first touch panel 12, and is an operation surface used by the customer for payment. The second surface is a surface including a surface of the second touch panel 22, and is an operation surface used by the shop assistant for payment.

According to this configuration, the customer and the shop assistant in a facing state can simultaneously operate the payment terminal 100 placed on the placement surface α. For example, when the payment terminal 100 is provided on the counter of the store, the shop assistant located inside the counter and the customer located outside the counter can operate the payment terminal 100 still in the facing state.

Further, in the payment terminal 100, the camera 25 and the first LED 13 are arranged on the front surface 1A side. On the front surface 1A side, the camera 25 and the first LED 13 may be arranged on the rear surface 1D side with respect to the first touch panel 12, that is, on a top side of the chevron shape, but this arrangement position is not limited thereto.

Further, in the payment terminal 100, the second LED 23 is arranged on the rear surface 1D side. On the rear surface 1D side, the second LED 23 may be arranged on the front surface 1A side with respect to the second touch panel 22, that is, on the top side of the chevron shape, but this arrangement position is not limited thereto.

Although the first touch panel 12 and the second touch panel 22 are shown as input means of the shop assistant and the customer, the payment terminal 100 may include other input means (for example, physical keys and buttons).

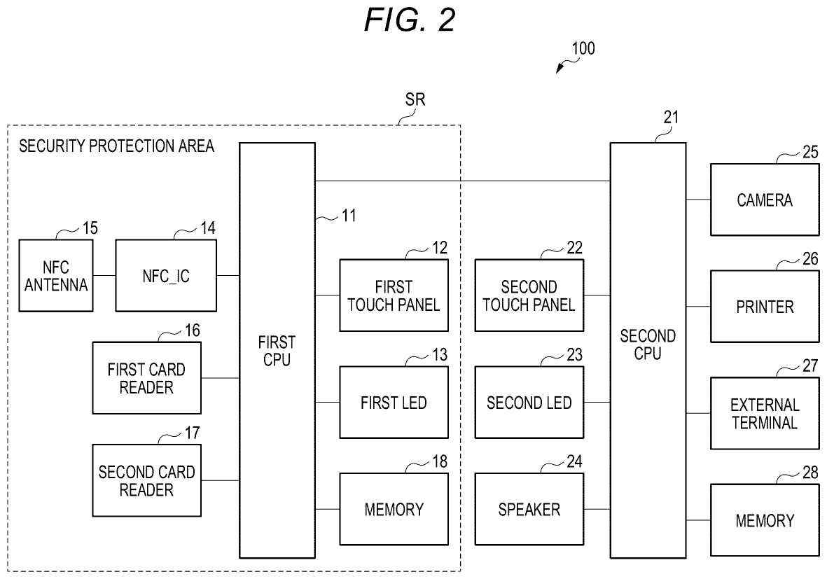

Further, the payment terminal 100 has a security protection area SR (see FIG. 2) in a part of the payment terminal 100. The security protection area SR is an area in which the security is increased compared to an area other than the security protection area SR in the payment terminal 100. For example, the security protection area SR has tamper resistance. The security of the security protection area SR may be logically increased by a software process, and the security may be physically increased by a hardware structure or mechanism. Members used for a payment process are mainly stored in the security protection area SR.

FIG. 2 is a block diagram showing an electrical configuration example of the payment terminal 100.

The payment terminal 100 has the security protection area SR. The payment terminal 100 includes a first central processing unit (CPU) 11, the first touch panel 12, the first LED 13, an NFC_IC 14, the NFC antenna 15, a first card reader 16, a second card reader 17, and a memory 18 inside the security protection area SR. The payment terminal 100 includes a second CPU 21, the second touch panel 22, the second LED 23, a speaker 24, the camera 25, a printer 26, an external terminal 27, and a memory 28 outside the security protection area SR.

The first CPU 11 implements various functions by executing a program stored in the memory 18. The first CPU 11 collectively controls individual parts in the security protection area SR. The first CPU 11 performs a process related to the credit card payment and the electronic money payment, for example. The first CPU 11 functions as a payment CPU that performs a process related to payment. Further, the first CPU 11 transmits and receives data to and from the second CPU 21, and cooperates with the second CPU 21. The first CPU 11 is an example of a processor, and may be another processor.

The first touch panel 12 has an input detection function of electrically detecting contact or proximity of a finger or the like (an example of an object) of the customer as an input (an input operation). The first touch panel 12 receives an input operation by the customer, for example. The first touch panel 12 receives, for example, a PIN input operation or an electronic sign operation in the credit card payment.

Further, the first touch panel 12 displays an image (also referred to as a payment assistance image) for assisting code payment. The payment assistance image includes, for example, a preview image PG or guidance information GI. The code payment is payment using a code such as a two-dimensional code.

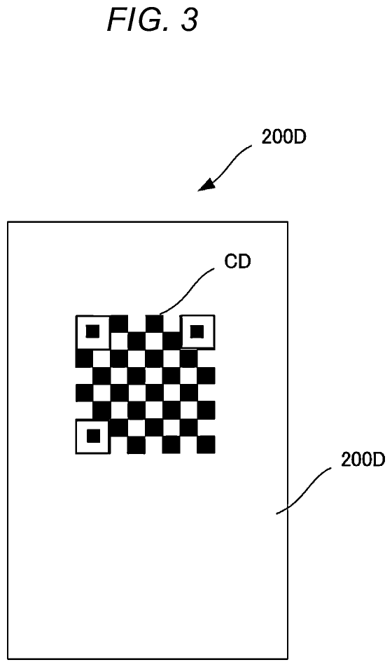

For example, the first touch panel 12 displays the preview image PG based on a captured image captured by the camera 25. The customer causes a display surface 200D (see FIG. 3) of a mobile terminal 200 to face the camera 25 in order to cause the camera 25 to capture an image, and as a result, the customer can confirm a state of the code displayed on the mobile terminal 200 with respect to the camera 25 by confirming the display of the preview image PG even in a state in which it is difficult for the customer to directly view the display surface 200D of the mobile terminal 200. The mobile terminal 200 is, for example, a smartphone, a tablet terminal, or another mobile terminal, and has the display surface 200D that displays a code CD.

In addition, the first touch panel 12 displays the guidance information GI for guiding an arrangement method (for example, an arrangement position and an arrangement duration) of the mobile terminal 200 with respect to the payment terminal 100 (for example, the camera 25) at the time of code payment. By confirming the guidance information GI, the customer can confirm how to perform the code payment using the mobile terminal 200. Further, the guidance information GI may include guidance information for setting the mobile terminal 200 into a predetermined arrangement state with respect to the payment terminal 100 for code reading. By confirming the guidance information GI, the customer can, for example, move the code CD displayed on the mobile terminal 200 to a position in which the payment terminal 100 can read the code CD.

The first LED 13 performs a display for notifying various kinds of information. The first LED 13 may display in various display forms. The display forms may include, for example, a display color (for example, red, green, and blue), a display timing (for example, display during the payment process and display when the payment is completed), and a display pattern (for example, turn-on, blinking, and turn-off).

The NFC_IC 14 performs a process for the NFC antenna 15. For example, the NFC_IC 14 controls power supply to the NFC antenna 15 and data communication via the NFC antenna 15.

The NFC antenna 15 is formed of, for example, a loop coil. The NFC antenna 15 receives the power supply from the NFC_IC 14 and generates a radio wave. An area within a predetermined distance from the NFC antenna 15 is an area (a non-contact communication possible area) in which non-contact communication with the NFC antenna 15 is possible. When the non-contact IC card C3 (an example of a communication medium possible in non-contact communication) is arranged in the non-contact communication possible area, the radio wave from the NFC antenna 15 reaches the non-contact IC card C3, and the NFC antenna 15 applies an activation power to the non-contact IC card C3. Accordingly, the NFC antenna 15 communicates data with the non-contact IC card C3.

Further, a center position of a surface defined by the NFC antenna 15 and a center position of the surface defined by the first touch panel 12 may substantially coincide with each other. Accordingly, by holding the non-contact IC card C3 with respect to the first touch panel 12, the data can be communicated between the NFC antenna 15 and the non-contact IC card C3, and the user can easily understand the operation.

The NFC_IC 14 acquires (reads) information stored in the non-contact IC credit card C31 via the NFC antenna 15. The NFC_IC 14 transmits this information to the first CPU 11 as non-contact read information. The information stored in the non-contact IC credit card C31 and the non-contact read information include, for example, the identification number of the credit card. Further, the NFC_IC 14 acquires (reads) information stored in the electronic money card C32 via the NFC antenna 15. The NFC_IC 14 transmits this information to the first CPU 11 as electronic money read information. The information stored in the electronic money card C32 and the electronic money read information include, for example, the identification number of the electronic money card C32.

The first card reader 16 is a magnetic card reader. The first card reader 16 reads information stored in the magnetic card C1 and transmits the read information as magnetic read information to the first CPU 11. The information stored in the magnetic card C1 and the magnetic read information include, for example, the identification number of the credit card.

The second card reader 17 is a contact IC card reader. The second card reader 17 reads information stored in the contact IC card C2 and transmits the read information as contact read information to the first CPU 11. The information stored in the contact IC card C2 and the contact read information include, for example, the identification number of the credit card.

The memory 18 may include, for example, a read only memory (ROM) or a random access memory (RAM). The memory 18 stores various data, information, programs, and the like. For example, the guidance information GI may be stored in the memory 18 on a first CPU 11 side in advance.

The second CPU 21 implements various functions by executing a program stored in the memory 28. The second CPU 21 collectively controls individual parts outside the security protection area SR. The second CPU 21 performs, for example, processes related to the code payment and the cash payment, and a process other than payment. Accordingly, the second CPU 21 functions as a general purpose CPU that performs a general purpose process. Further, the second CPU 21 transmits and receives data to and from the first CPU 11, and cooperates with the first CPU 11. The second CPU 21 is an example of a processor, and may be another processor. The second CPU 21 may have higher performance than the first CPU 11.

The second CPU 21 acquires, from the camera 25, a captured image obtained by capturing a subject displayed on the mobile terminal 200. The second CPU 21 analyzes the captured image, and recognizes identification information necessary for payment indicated by the code. The second CPU 21 performs a payment process related to the code payment using this identification information.

Further, the second CPU 21 performs various processes for assisting the code payment. These processes may include a process related to display assistance of the preview image PG based on the captured image captured by the camera 25. These processes may include a process related to display assistance of the guidance information GI indicating the arrangement method of the mobile terminal 200 with respect to the payment terminal 100 at the time of code payment. These process may include a process related to display assistance of the guidance information GI for guiding the mobile terminal 200 to a predetermined position, a distance, or a posture with respect to the payment terminal 100 for code reading.

The second CPU 21 plays a leading role in controlling the display of the payment assistance image (for example, the preview image PG and the guidance information GI). When displaying the payment assistance image by the first touch panel 12, the second CPU 21 transmits a preview image PG1 as the payment assistance image to the first CPU 11, and instructs the first touch panel 12 to display the payment assistance image. The first touch panel 12 displays the payment assistance image according to the instruction from the second CPU 21 via the first CPU 11. Further, when displaying a preview image PG2 by the second touch panel 22, the second CPU 21 instructs the second touch panel 22 to display the preview image PG2 simultaneously with the display of the preview image PG1 in synchronization with displaying the preview image PG1 by the first touch panel 12.

The second touch panel 22 receives an input operation by the shop assistant, for example. For example, a purchase amount input and a purchase quantity input of the product in product purchase are performed. The second CPU 21 calculates a payment amount based on, for example, the purchase amount and the purchase quantity of the product. Further, the second touch panel 22 may receive a direct input of the payment amount. The second CPU 21 may acquire information on the payment amount from a POS serving as an external device via a communication unit to be described later. The second touch panel 22 may have the same configuration as that of the first touch panel 12.

The second LED 23 performs a display for notifying various kinds of information. The second LED 23 may display in various display forms. The display forms may include, for example, a display color (for example, red, green, and blue), a display timing (for example, display when purchase information is input), and a display pattern (for example, turn-on, blinking, and turn-off).

The speaker 24 outputs various sounds. The speaker 24 outputs, for example, a sound related to the process in the payment terminal 100.

The camera 25 captures an image of the subject, and acquires a captured image. The camera 25 captures an image of the code displayed on the mobile terminal 200 of the customer, and transmits the captured image to the second CPU 21.

The printer 26 outputs, for example, information related to the process (for example, the payment process) in the payment terminal 100 to a paper medium. For example, the printer 26 may print a result of the payment process on a receipt or the like after the payment process.

The external terminal 27 can be connected to various cables (for example, a local area network (LAN) cable and a universal serial bus (USB) cable). Therefore, the external terminal 27 can be connected to various external devices (for example, the POS and a cash drawer) and can communicate with the external devices via various cables. Accordingly, the external terminal 27 functions as the communication unit. The communication unit may perform wireless communication (for example, wireless LAN communication and Bluetooth (registered trademark) communication) without using the external terminal 27.

The memory 28 may include, for example, a ROM or a RAM. The memory 28 stores various data, information, programs, and the like.

Next, an operation example of the payment terminal 100 will be described.

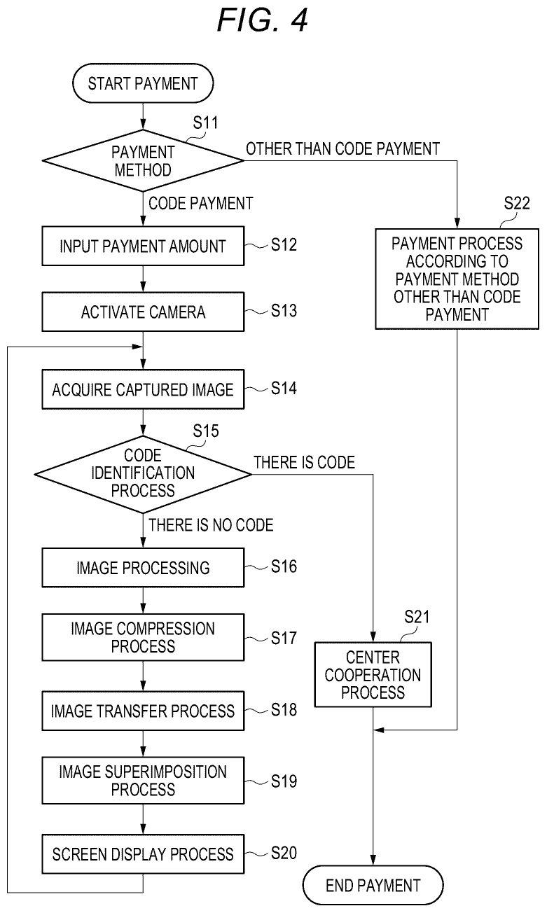

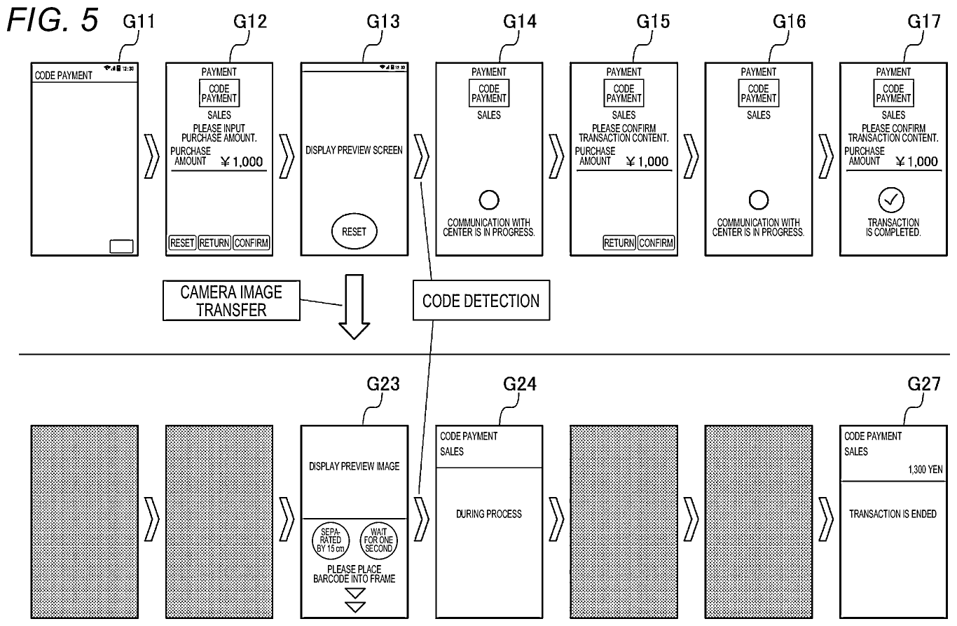

FIG. 4 is a flowchart showing the operation example of the payment terminal 100. FIG. 5 is a diagram showing a transition example of screen display during the payment process performed by the payment terminal 100. In FIG. 5, screen displays of the first touch panel 12 and the second touch panel 22 are shown side by side in time series. In FIG. 5, screens G11 to G17 are screen examples displayed on the second touch panel 22, and screens G23, G24, and G27 are screen examples displayed on the first touch panel 12.

First, the second CPU 21 designates the payment method (S11). In this case, for example, the shop assistant operates the second touch panel 22, the second touch panel 22 receives the input operation, and the second CPU 21 designates the payment method according to this input operation.

When the code payment is designated as the payment method, the second CPU 21 performs the payment process according to the code payment as the payment method. The second CPU 21 causes the second touch panel 22 to display a screen (for example, the screen G11 in FIG. 5) for guiding the code payment. Then, the second CPU 21 causes the second touch panel 22 to display a screen (for example, the screen G12 in FIG. 5) for inputting the payment amount. For example, the second CPU 21 acquires information on the payment amount by receiving an input operation related to the payment amount from the shop assistant via the second touch panel 22 (S12).

The second CPU 21 activates the camera 25 (camera: ON) (S13). The second CPU 21 acquires an image (a captured image) captured by the camera 25 (S14). The second CPU 21 performs image analysis on the captured image and identifies whether the code CD is included in the captured image, that is, whether the code CD is visible in the captured image (a code identification process) (S15).

When the code is not included in the captured image, the second CPU 21 processes the captured image (an image processing) to generate the preview image PG (S16). In the image processing, the second CPU 21 resizes (size adjustment) the size (a display size) of the captured image based on a screen size (for example, a vertical length and a horizontal length of the screen) of the first touch panel 12 to generate the preview image PG1 which is a preview of the captured image. The preview image PG1 is an image displayed on the first touch panel 12. The second CPU 21 resizes (size adjustment) the size (a display size) of the captured image based on a screen size (for example, a vertical length and a horizontal length of the screen) of the second touch panel 22 to generate the preview image PG2. The preview image PG2 is an image displayed on the second touch panel 22. The image processing may be omitted.

The second CPU 21 compresses the captured image (an image compression process) to generate the preview image PG (S17). The captured image here is, for example, the captured image processed in step S16 (the processed image, that is, the preview image PG acquired at the time of step S16), and may be the captured image acquired in step S14. In the compression of the captured image, for example, the second CPU 21 degrades an image quality of the captured image (for example, a JPEG image) to reduce the data size of the captured image. In this case, the second CPU 21 generates the preview image PG1 and the preview image PG2 by compressing the captured image. Accordingly, the payment terminal 100 can improve the reactivity of the preview image PG by reducing the data size even when a bandwidth of a communication path between the first CPU 11 and the second CPU 21 is not wide. Compression rates at the time of generating the preview image PG1 and the preview image PG2 may be the same or different.

Compression rates at the time of generating the preview image PG1 and the preview image PG2 may be the same or different. That is, the second CPU 21 may compress the captured image at a compression rate cr1 to generate the preview image PG1. The second CPU 21 may compress the captured image at a compression rate cr2 to generate the preview image PG2. The compression rate cr1 and the compression rate cr2 may be the same or different. The second CPU 21 may generate the preview image PG2 without compressing the captured image.

The payment terminal 100 is divided into the security protection area SR and a non-security protection area, and the arrangement positions of two touch panels (the first touch panel 12 and the second touch panel 22) are also separated. Therefore, it is necessary to transfer an image to each touch panel. Also in this case, the payment terminal 100 can minimize a delay at the time of image transfer by the image compression process. The image compression process may be omitted.

When both the image processing in step S16 and the image compression process in step S17 are omitted, the second CPU 21 sets the captured image acquired in step S14 as the preview image PG (PG1, PG2) as it is.

The second CPU 21 transfers the preview image PG to each touch panel (an image transfer process) (S18). In this case, the second CPU 21 transfers the preview image PG1 to the first CPU 11 and transfers the preview image PG2 to the second touch panel 22. The code identification process for identifying whether the code CD is included in

the captured image, the image processing and the image compression process for generating the preview image PG, and the image transfer process for transmitting (transferring) the preview image PG may be performed in parallel. For example, even when the code CD is included in the captured image captured for the first time, the second CPU 21 may generate the preview image PG based on the captured image and transmit the preview image PG via the communication unit. When it is recognized by the code identification process that the code CD is included in the captured image, the second CPU 21 may stop the image processing or the image compression process for generating the preview image PG, and the image transfer process for transmitting the preview image PG.

The first CPU 11 acquires the preview image PG1 from the second CPU 21, acquires the guidance information GI from the memory 18, and superimposes the preview image PG1 and the guidance information GI (an image superimposition process) to generate a superimposed image (S19). The first CPU 11 instructs the first touch panel 12 to display the superimposed image. The guidance information GI may be stored in the memory 28, and the first CPU 11 may acquire the guidance information GI from the second CPU 21. For example, the first CPU 11 may acquire the information on the payment amount input via the second touch panel 22 from the second CPU 21, and may instruct the first touch panel 12 to include payment amount information PI in the superimposed image and display the superimposed image.

The first touch panel 12 acquires the superimposed image from the first CPU 11 and displays the superimposed image (S20). At this time, the first CPU 11 causes the first touch panel 12 to display, for example, a screen (for example, the screen G23 in FIG. 5) including the superimposed image including the preview image PG1 and the guidance information GI. The second touch panel 22 acquires the preview image PG2 from the second CPU 21 and displays the preview image PG2 (S20). At this time, the second CPU 21 causes the second touch panel 22 to display a screen (for example, the screen G13 in FIG. 5) including the preview image PG2. When the process of step S20 ends, the process proceeds to step S14.

That is, when it is determined in step S15 that the code CD is not included in the captured image, the payment terminal 100 causes the first touch panel 12 to display the preview image PG1 and the guidance information GI, and assists the customer to be capable of arranging the mobile terminal 200 at a desired position with respect to the payment terminal 100. Further, in this case, the payment terminal 100 causes the second touch panel 22 to display the preview image PG2, and can assist the shop assistant to prompt the customer so as to be capable of arranging the mobile terminal 200 at the desired position with respect to the payment terminal 100. The image capturing by the camera 25 is sequentially performed. When the customer moves the position of the mobile terminal 200 according to the preview image PG1, the guidance information GI, or an advice from the shop assistant, the movement is reflected in the captured image, and it can be expected that the code CD is included in the captured image. The payment terminal 100 can continue such assistance until the code CD is included in the captured image in step S15.

When it is determined in the code identification process of step S15 that the code CD is included in the captured image, the second CPU 21 acquires (reads) the identification information indicated by the code CD as code reading information. The second CPU 21 performs the payment process using the code reading information in cooperation with an external server (for example, a server of a payment center) for performing the code payment (a center cooperation process) (S21).

In the payment process (the center cooperation process), for example, the following process is performed. The second CPU 21 transmits payment request information including the code reading information and the payment amount to the server of the payment center via the communication unit (for example, the external terminal 27). At this time, the second CPU 21 causes the second touch panel 22 to display a screen (for example, the screen G14 in FIG. 5) indicating that communication with the server of the payment center is in progress. Further, at this time, the second CPU 21 causes the first touch panel 12 via the first CPU 11 to display a screen (for example, the screen G24 in FIG. 5) indicating that the center cooperation process is in progress. Then, the second CPU 21 causes the second touch panel 22 to display a confirmation screen (for example, the screen G15 in FIG. 5) for payment details. Then, when the second CPU 21 receives a confirmation instruction (for example, pressing of a confirmation button) related to the confirmation screen for the payment details via the second touch panel 22, the second CPU 21 transmits the confirmation instruction to the external server via the communication unit. At this time, the second CPU 21 causes the second touch panel 22 to display a screen (for example, the screen G16 in FIG. 5) indicating that communication with the server of the payment center is in progress. The external server receives the confirmation instruction and the payment request information from the payment terminal 100, collates the received information with information stored in the external server, subtracts the payment amount from a retention amount associated with the identification number indicated by the code, sets a subtraction result as a new retention amount, and completes the transaction of the product purchase. The external server transmits a payment completion notification to the payment terminal 100. When receiving the payment completion notification via the communication unit, the second CPU 21 completes the payment process. At this time, the second CPU 21 causes the second touch panel 22 to display a screen (for example, the screen G17 in FIG. 5) indicating the completion of the payment process. Further, at this time, the second CPU 21 causes the first touch panel 12 via the first CPU 11 to display a screen (for example, the screen G27 in FIG. 5) indicating the completion of the payment process. The flow of the payment process is not limited to this example.

In the screen transition example of FIG. 5, the code is detected after the screen G13 including the preview image PG1 and the screen G23 including the preview image PG2 are displayed. This indicates, as an example, that when the customer adjusts the position of the mobile terminal 200 with respect to the payment terminal 100 based on the preview image PG1 or the preview image PG2, the code CD is detected in the captured image by the code identification process of the second and subsequent step S15 repeated in the process of FIG. 4, and the center cooperation process of step S21 is performed based on the read information of the code CD.

In step S11, when a payment method other than the code payment (for example, the credit card payment, the electronic money payment, or the cash payment) is designated, the first CPU 11 or the second CPU 21 performs a payment process according to the payment method in cooperation with an external device (for example, the server of the payment center) as necessary (S22). This payment process may be a known payment process, and for example, read information of various cards is used.

According to such an operation example, the customer can intuitively understand the current arrangement position of the mobile terminal 200 with respect to the payment terminal 100 (for example, the camera 25) at the time of code payment by confirming a screen (for example, the screen G23) on which the superimposed image is displayed. Therefore, the customer can understand whether the mobile terminal 200 is held at an appropriate position with respect to the payment terminal 100. The customer can move the position of the mobile terminal 200 to a desired position in consideration of the arrangement position. Therefore, the customer can easily achieve adjustment of the position of the mobile terminal 200 to an appropriate focal length of the camera or to a desired range in which the code is easily read in the imaging range of the camera 25. Accordingly, the customer can adjust the position and a direction of the mobile terminal 200 such that the code CD displayed on the display surface 200D of the mobile terminal 200 is located at a desired position, has a desired size, or has a desired shape. In addition, by confirming the screen (for example, the screen G13) on which the preview image PG2 is displayed, the shop assistant can easily advice the position or the direction in which the mobile terminal 200 is to be moved to the customer.

The preview images PG1 and PG2 may be still images captured at a predetermined time point, and may be videos captured during a predetermined period. That is, in the image compression process, the second CPU 21 of the payment terminal 100 may treat continuous images as a video in a compression scheme and apply a compression algorithm for the video. In this case, the camera 25 may capture a video including a plurality of images sequentially captured in time series. The second CPU 21 of the payment terminal 100 may acquire the video (a captured video) captured by the camera 25 via the communication unit. The second CPU 21 may perform various processes (for example, the code identification process, the image processing, the image compression process, the image transfer process, the image superimposition process, and an image display process) on the captured video. For example, in the image compression process, the second CPU 21 may compress the captured video at a compression rate cr3 to generate a preview video PV1 as the preview image PG1. Further, in the image compression process, the second CPU 21 may compress the captured video at a compression rate cr4 to generate a preview video PV2 as the preview image PG2. The compression rate cr3 and the compression rate cr4 may be the same or different. Further, the second CPU 21 may generate the preview video PV2 without compressing the captured video. Further, in the image transfer process, the second CPU 21 may transfer the preview video PV1 to the first touch panel 12 and transfer the preview video PV2 to the second touch panel 22. Further, in the image display process, the second CPU 21 may cause the preview video PV2 to be displayed on the second touch panel 22 while simultaneously causing the preview video PV1 to be displayed on the first touch panel 12.

Next, a specific example of the display on the screen G23 will be described.

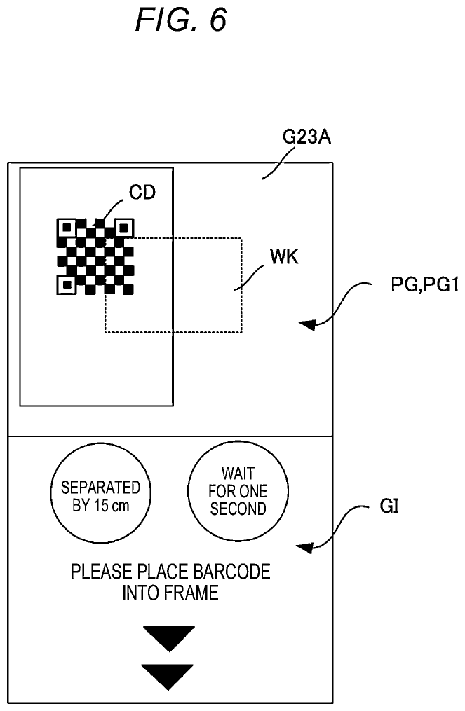

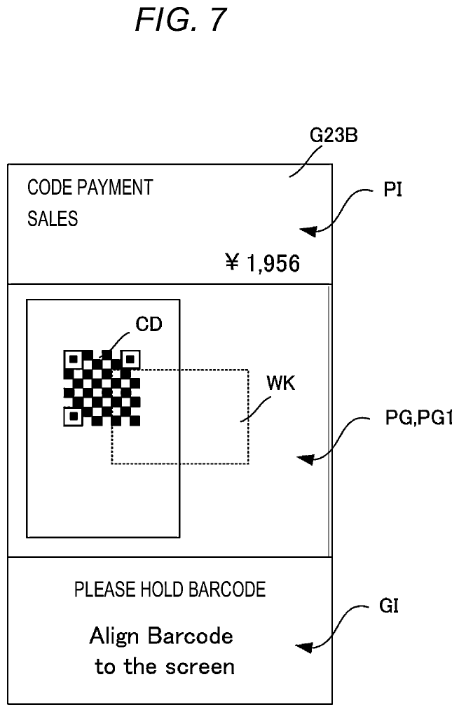

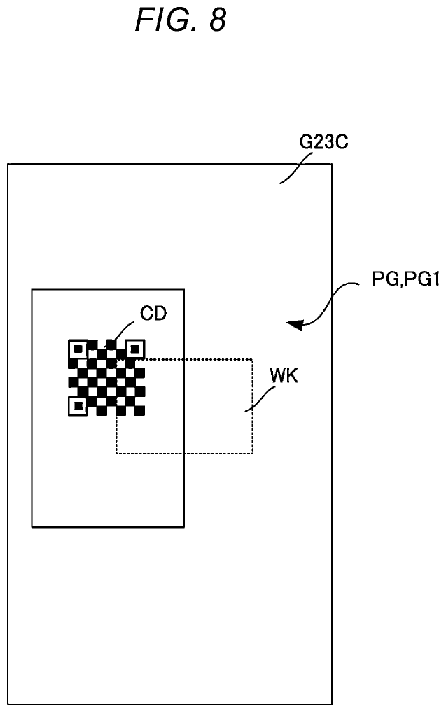

FIG. 6 is a diagram showing a first example (a screen G23A) of the screen G23 on which an image including the preview image PG1 for the customer is displayed. FIG. 7 is a diagram showing a second example (a screen G23B) of the screen G23 including the preview image PG1 for the customer. FIG. 8 is a diagram showing a third example (a screen G23C) of the screen G23 including the preview image PG1 for the customer.

In FIG. 6, the preview image PG1 is displayed on the screen G23 A together with the guidance information GI. In FIG. 6, the guidance information GI may include a frame WK indicating a contour of a range in which the code CD is to be located in the imaging range of the camera 25. The guidance information GI may include information indicating how far the mobile terminal 200 should be separated from the payment terminal 100 (for example, separated by 15 cm) and how long a state in which the mobile terminal 200 is arranged at a desired position with respect to the camera 25 should be continued (for example, wait for one second). Further, the guidance information GI may include information on an instruction for causing the code CD to be arranged in the frame WK (for example, a message “please place barcode into frame”). According to this display, the customer can confirm the behavior to be taken by the customer based on the guidance information GI, and can confirm the current arrangement position of the mobile terminal 200 with respect to the payment terminal 100 based on the preview image PG.

In FIG. 7, the payment amount information PI is displayed on the screen G23B together with the preview image PG and the guidance information GI. The guidance information GI may include, for example, a message “please hold barcode”. According to this display, the customer can confirm the behavior to be taken by the customer based on the guidance information GI, can confirm the current arrangement position of the mobile terminal 200 with respect to the payment terminal 100 based on the preview image PG, and can confirm the payment amount based on the payment amount information PI.

In FIG. 8, only the preview image PG is displayed on the screen G23C without displaying the guidance information GI and the like. In this case, the payment terminal 100 can enlarge and display the preview image PG on a display surface of the first touch panel 12. Therefore, according to this display, the customer can confirm the current arrangement position of the mobile terminal 200 with respect to the payment terminal 100 in detail.

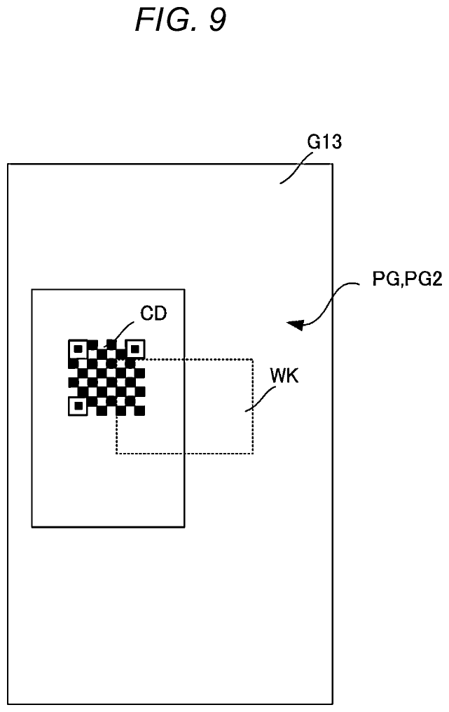

As shown in FIG. 9, at least the preview image PG (PG2) is displayed on the screen G13 for the shop assistant displayed on the second touch panel 22. The preview image PG2 may be different from the preview image PG1 in the compression rate and the display size. Further, similarly to the screen G23A, the screen G23B, or the like, the screen G13 may display the guidance information GI together with the preview image PG. The guidance information GI may be acquired via the memory 18, the first CPU 11, and the second CPU 21, and may be acquired from the memory 28.

In this way, the payment terminal 100 according to the present embodiment can cause the customer to directly view an actual imaging result by the preview image PG. Accordingly, the customer can adjust the arrangement of the mobile terminal 200 with respect to the payment terminal 100. Further, the payment terminal 100 can also provide information on an adjustment method of the mobile terminal 200, which is difficult to determine by only viewing the imaging result, by also displaying the guidance information GI. Further, since the payment terminal 100 displays the preview images PG (PG1, PG2) on both the first touch panel 12 and the second touch panel 22, the shop assistant can prompt the customer to adjust the position of the mobile terminal 200 with respect to the payment terminal 100 based on the preview image PG2 displayed on the second touch panel 22.

### Second Embodiment

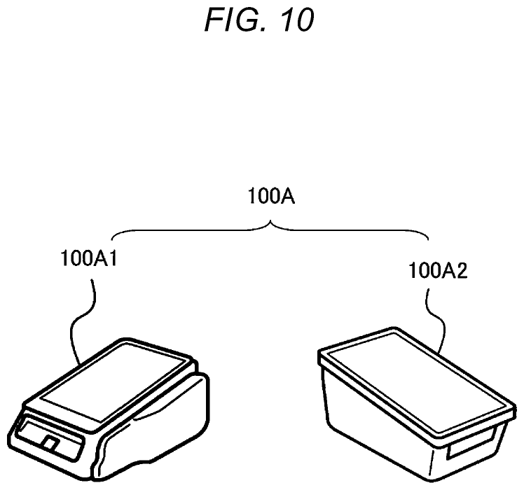

In the first embodiment, it is illustrated that the payment terminal 100 as one terminal includes two display units (for example, the first touch panel 12 and the second touch panel 22). In a second embodiment, as shown in FIG. 10, it is described that a payment terminal 100A includes a customer terminal 100A1 and a store terminal 100A2 as two terminals. In the second embodiment, the description of the same matters as those in the first embodiment will be omitted or simplified.

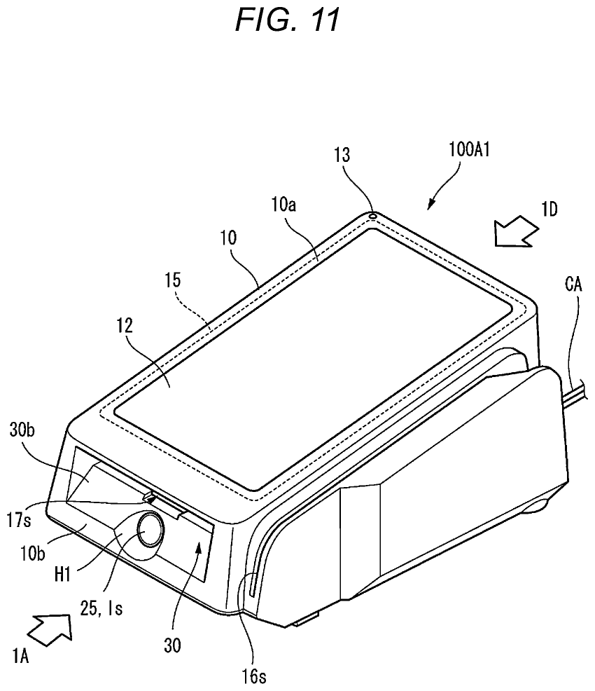

FIG. 11 is a front perspective view showing an appearance example of the customer terminal 100A1. The customer terminal 100A1 includes the main body 10. The main body 10 has, for example, a general box shape. For example, the customer operates the customer terminal 100A1 from the front surface 1A side of the customer terminal 100A1. The customer terminal 100A1 is connected to the store terminal 100A2 operated by the shop assistant. The customer terminal 100A1 can execute various payment processes in cooperation with the store terminal 100A2. The store terminal 100A2 performs, for example, a product input, a purchase amount input, a selection of the payment method, and the like via an input device included in the store terminal 100A2.

The customer terminal 100A1 includes the first touch panel 12, the first LED 13, the NFC antenna 15, the first card slot 16s, the second card slot 17s, and the camera 25. The customer terminal 100A1 includes a cable CA on the rear surface 1D side. The cable CA may include a power cable, a communication cable, a local area network (LAN) cable, a universal serial bus (USB) cable, and the like.

The customer terminal 100A1 is a combined type that can execute the payment process according to a plurality of payment methods in cooperation with the store terminal 100A2.

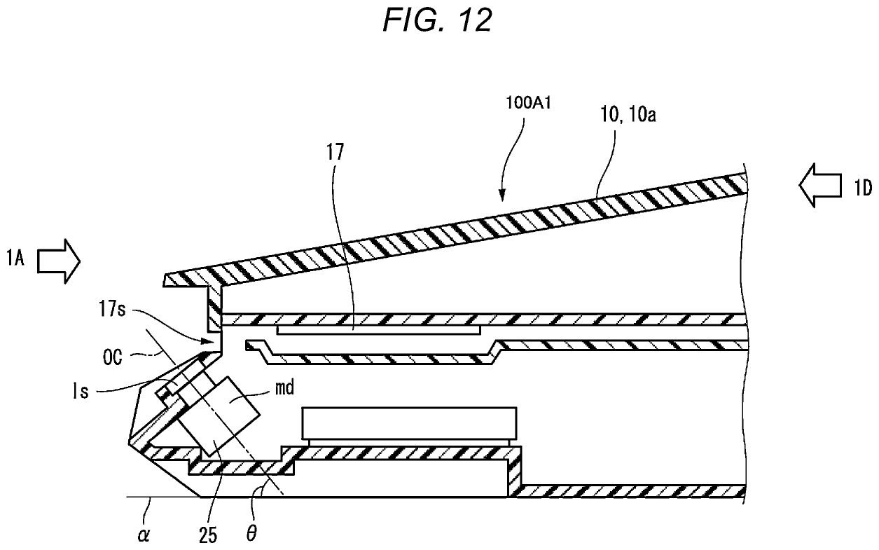

The camera 25 includes a camera module md and a lens 1s (see FIG. 12). In the customer terminal 100A1, when viewed from the outside of the customer terminal 100A1, the lens 1s of the camera 25, the second card slot 17s, and the first touch panel 12 are arranged in order from proximity with the placement surface α in the height direction from the placement surface α. Further, in the customer terminal 100A1, when viewed from the inside of the customer terminal 100A1, the camera module md of the camera 25, the second card reader 17, the NFC antenna 15, and the first touch panel 12 are arranged in order from proximity with the placement surface α in the height direction from the placement surface α. The NFC antenna 15 and the first touch panel 12 may have the same height from the placement surface α, that is, the NFC antenna 15 may be arranged around the first touch panel 12 on the same surface. The surface on which the first touch panel 12 is arranged is also referred to as a panel arrangement surface 10a. The panel arrangement surface 10a may be an upper surface of the main body 10.

The first card slot 16s is arranged along a side surface on the right or left side when viewed from the front surface 1A side, for example, on the right side in FIG. 11. In this case, the customer can easily select any payment method among a plurality of payment methods corresponding to a plurality of devices arranged in front of the customer's eye.

The customer terminal 100A1 is higher on the rear surface 1D side than on the front surface 1A side. That is, the panel arrangement surface 10a of the main body 10 of the customer terminal 100A1 is gradually lowered toward the customer side. That is, when the customer faces the front side of the second card slot 17s, an orientation of the panel arrangement surface 10a of the customer terminal 100A1 faces obliquely upward toward the customer.

The first LED 13 is arranged on the panel arrangement surface 10a of the main body 10 of the customer terminal 100A1. The arrangement position of the first LED 13 is not limited thereto, and may be any position that can be viewed by the customer.

The customer terminal 100A1 includes, on the front surface 1A, an opening 30 in which a housing of the main body 10 is absent. The opening 30 is widest on the front surface 1A side, and becomes narrower toward the rear surface 1D side. That is, the opening 30 is enlarged from the rear surface 1D side toward the front surface 1A side. The second card slot 17s and the lens 1s of the camera 25 are arranged in the opening 30. For example, the second card slot 17s is located at a portion of the opening 30 closest to the rear surface 1D side.

A lower surface 30b is arranged at a lower portion of a peripheral end of the opening 30. The lower surface 30b may be a tapered surface gradually approaching the placement surface α from the rear surface 1D side toward the front surface 1A side. The lower surface 30b is formed in, for example, a substantially planar shape. A surface 10b of the main body 10 of the customer terminal 100A1, which is located at a perimeter lower portion of the opening 30 on the front surface 1A side, is connected to the lower surface 30b. A part of a connection portion between the surface 10b of the main body 10 and the lower surface 30b of the opening 30 has a recessed shape, and forms a recess H1. The recess H1 is a part of the opening 30. A contour of the recess H1 has, for example, a semicircular arc shape or a semi-elliptical arc shape. The lens 1s of the camera 25 is arranged to be exposed in the recess H1. The front surface side of the lens 1s is not covered with the housing of the main body 10. Therefore, the camera 25 can introduce light from the outside of the customer terminal 100A1 through the recess H1. Further, since the lens 1s is arranged in the recess H1, the finger of the customer at the time of payment, dust, or the like hardly reaches the lens Is, and the lens 1s is protected from damage or adhesion of dirt.

FIG. 12 is a schematic cross-sectional view showing an example of the customer terminal 100A1 in transparency as viewed from a side surface. In FIG. 12, the first touch panel 12, the NFC antenna 15, and the like are not shown.

In the customer terminal 100A1, the camera 25 may be arranged closer to the front surface 1A side (the left side in FIG. 12) than the second card slot 17s. That is, when the customer faces the front side of the second card slot 17s, the lens 1s of the camera 25 may be arranged at a position closer to the customer than the second card slot 17s. In this case, since the lens 1s of the camera 25 is relatively located on the front surface 1A side in the opening 30, the customer terminal 100A1 easily introduces light from a subject (for example, the mobile terminal 200 on which the code is displayed) located outside the customer terminal 100A1. Accordingly, the customer terminal 100A1 can capture an image of the code CD displayed on the display surface of the mobile terminal 200 with high image quality, and can improve the recognition accuracy of the code.

Further, in the customer terminal 100A1, the camera 25 is arranged at a position closer to the placement surface α than the second card slot 17s. For example, a distance between the placement surface α and an arrangement position of the second card slot 17s, that is, a distance between the placement surface α and the contact IC card C2 inserted into the second card slot 17s may be a length by which the finger of the customer who is going to insert the contact IC card C2 can enter between the contact IC card C2 and the placement surface α.

Accordingly, even at the arrangement position of the camera 25 according to the present embodiment, the customer can insert the contact IC card C2 into the second card slot 17s, and can perform the payment using the contact IC card C2. Further, on a side closer to the placement surface α than the second card slot 17s, a dead space is likely to be formed inside the customer terminal 100A1. By arranging the camera 25 at such a position, the dead space inside the customer terminal 100A1 can be effectively used, and the arrangement efficiency of the camera 25 can be improved. This leads to downsizing of the customer terminal 100A1 including the camera 25.

Further, a normal direction to the lens 1s of the camera 25, that is, a direction of an optical axis OC (an optical axis direction) of the lens 1s forms a predetermined angle θ (for example, about 50 degrees) with respect to the placement surface α. That is, the optical axis direction of the camera 25 is obliquely upward toward the customer.

When the payment terminal 100A is divided into the customer terminal 100A1 and the store terminal 100A2, the customer terminal 100A1 may not have the above configuration, and the customer terminal 100A1 has any appearance configuration. Further, the store terminal 100A2 also has any appearance configuration.

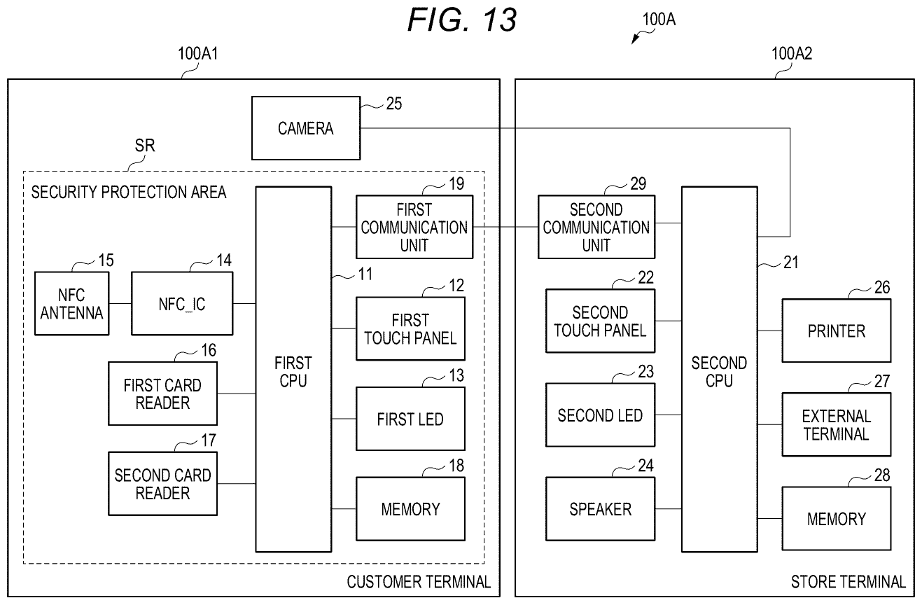

FIG. 13 is a block diagram showing an electrical configuration example of the payment terminal 100A. In FIG. 13, the same components as those in the electrical configuration of the payment terminal 100 shown in FIG. 2 are denoted by the same reference numerals, and the description thereof is omitted or simplified.

In the payment terminal 100A, the customer terminal 100A1 includes the components arranged inside the security protection area SR in the payment terminal 100 shown in FIG. 2. In the payment terminal 100A, the store terminal 100A2 includes the components arranged outside the security protection area SR in the payment terminal 100 shown in FIG. 2. Further, although it is illustrated that the customer terminal 100A1 has the security protection area SR, the customer terminal 100A1 may not include the security protection area SR.

Specifically, the customer terminal 100A1 includes the first CPU 11, the first touch panel 12, the first LED 13, the NFC_IC 14, the NFC antenna 15, the first card reader 16, the second card reader 17, and the memory 18 inside the security protection area SR. Further, the customer terminal 100A1 also includes a first communication unit 19.

Specifically, the store terminal 100A2 includes the second CPU 21, the second touch panel 22, the second LED 23, the speaker 24, the printer 26, and the memory 28 outside the security protection area SR. Further, the store terminal 100A2 also includes a second communication unit 29.

The first communication unit 19 communicates data with an external device (for example, the store terminal 100A2) via wire (for example, the cable CA) or wirelessly. A second communication unit 29 communicates data with an external device (for example, the customer terminal 100A1) via wire or wirelessly.

Next, an operation example of the payment terminal 100A will be described.

The operation example of the payment terminal 100A according to the present embodiment is the same as the operation example of the payment terminal 100 according to the first embodiment. In the payment terminal 100A, since the customer terminal 100A1 and the store terminal 100A2 are separated from each other, data is transmitted and received between the components provided in the customer terminal 100A1 and the components provided in the store terminal 100A2 by communication via the first communication unit 19 and the second communication unit 29. Therefore, when the captured image is compressed by the image compression process, an amount of data communication between the first communication unit 19 and the second communication unit 29 can be reduced in the image transfer process. Therefore, the first touch panel 12 of the customer terminal 100A1 and the second touch panel 22 of the store terminal 100A2 can smoothly restrain the delay and display a screen including the preview image PG.

Screen display examples of the payment terminal 100A in the present embodiment are the same as those in the first embodiment, that is, the same as the screen display examples shown in FIGS. 5 to 9.

In this way, according to the payment terminal 100A of the present embodiment, even when the payment terminal is separated into two terminals (the customer terminal 100A1 and the store terminal 100A2), the same effect as that of the payment terminal 100 according to the first embodiment can be obtained.

Further, when the customer terminal 100A1 has the configuration as shown in FIGS. 11 and 12, the camera 25 is present at the position close to the placement surface α. In addition, the opening 30 and the recess H1 exist around the camera 25, and the optical axis direction of the lens 1s of the camera 25 is inclined with respect to the placement surface α or a direction perpendicular to the placement surface α. Therefore, in the customer terminal 100A1, the periphery of the camera 25 has a complicated shape. Also in this case, when the customer brings the mobile terminal 200 on which the code CD is displayed close to the camera 25, the customer can adjust the position of the mobile terminal 200 while confirming the preview image PG1 and the guidance information GI, and thus it is easy to operate such that the code CD is preferably included in the imaging range of the camera 25. Therefore, the payment terminal 100A can easily guide the position of the mobile terminal 200 with respect to the camera 25 which captures an image of the code CD displayed on the mobile terminal 200.

### Overview of Embodiments of the Present Disclosure

As described above, the payment terminals 100 and 100A according to the above embodiments are payment terminals capable of performing payment using the code CD. The payment terminal 100 includes the first touch panel 12 (an example of a first display unit), the second touch panel 22 (a second display unit), the camera 25 (an example of an imaging unit) that is arranged near the first touch panel 12 and captures an image of the code CD displayed on the mobile terminal 200 (an example of a medium), and the second CPU 21 (an example of a control unit) that controls the first touch panel 12, the second touch panel 22, and the camera 25. The second CPU 21 acquires the captured image captured by the camera 25, and causes the preview image PG1 (an example of a first preview image) based on the captured image to be displayed on the first touch panel 12 while simultaneously causing the preview image PG2 (an example of a second preview image) based on the captured image to be displayed on the second touch panel 22.

Accordingly, the payment terminals 100 and 100A display the preview images PG (PG1, PG2) on the first touch panel 12 and the second touch panel 22. Therefore, the customer can confirm the preview image PG2 and then confirm the current arrangement position of the mobile terminal 200 with respect to the camera 25, and can easily adjust the position of the mobile terminal 200. Further, the shop assistant can confirm the preview image PG2 displayed on the second touch panel 22 and prompt the customer to adjust the position of the mobile terminal 200 with respect to the camera 25. Therefore, the payment terminals 100 and 100A can easily guide the position of the medium with respect to the camera 25 which captures an image of the code CD displayed on the medium.

Further, the payment terminal 100A may include the customer terminal 100A1 (an example of a first terminal) and the store terminal 100A2 (an example of a second terminal). The customer terminal 100A1 may include the first touch panel 12 and the camera 25. The store terminal 100A2 may include the second touch panel 22 and the second CPU 21. The second CPU 21 may acquire the captured image from the camera 25 of the customer terminal 100A1 and compress the captured image at the compression rate cr1 (an example of a first compression rate) to generate the preview image PG1. The second CPU 21 may compress the captured image at the compression rate cr2 (an example of a second compression rate) different from the compression rate cr1 or at the compression rate cr2 the same as the compression rate cr1 to generate the preview image PG2, or may generate the preview image PG2 without compressing the captured image. The second CPU 21 may transfer the preview image PG1 to the first touch panel 12, and transfer the preview image PG2 to the second touch panel 22. The second CPU 21 may cause the preview image PG1 to be displayed on the first touch panel 12 while simultaneously causing the preview image PG2 to be displayed on the second touch panel 22.

Accordingly, by setting the compressed captured videos as the preview videos PV1 and PV2, the payment terminal 100A can reduce the amount of data transferred when the preview video PV1 is transferred from the second CPU 21 to the first touch panel 12 and when the preview video PV2 is transferred from the second CPU 21 to the second touch panel 22, and can reduce the delay of the preview video PV1 as a real-time image. Therefore, the customer and the shop assistant can more accurately grasp the current arrangement position of the mobile terminal 200 with respect to the camera 25.

Further, the second CPU 21 may acquire, as the captured image, a captured video including a plurality of images captured sequentially in time series by the camera 25. The second CPU 21 may compress the captured video at the compression rate cr3 (an example of a third compression rate) to generate the preview video PV1 (an example of a first preview video) as the preview image PG1. The second CPU 21 may compress the captured video at the compression rate cr4 (an example of a fourth compression rate) different from the compression rate cr3 or at the compression rate cr4 the same as the compression rate cr3 to generate the preview video PV2 (an example of a second preview video) as the preview image PG2, or may generate the preview video PV2 as the preview image PG2 without compressing the captured video. The second CPU 21 may transfer the preview video PV1 to the first touch panel 12, and transfer the preview video PV2 to the second touch panel 22. The second CPU 21 may cause the preview video PV1 to be displayed on the first touch panel 12 while simultaneously causing the preview video PV2 to be displayed on the second touch panel 22.

Accordingly, by setting the compressed captured images as the preview images PG1 and PG2, the payment terminal 100A can reduce the amount of data transferred when the preview image PG1 is transferred from the second CPU 21 to the first touch panel 12 and when the preview image PG2 is transferred from the second CPU 21 to the second touch panel 22, and can reduce the delay of the preview video PV1 as a real-time video. Therefore, the customer and the shop assistant can more accurately grasp the current arrangement position of the mobile terminal 200 with respect to the camera 25.

Further, the screen size of the first touch panel 12 may be different from the screen size of the second touch panel 22. The second CPU 21 may generate the preview image PG1 by adjusting the display size of the captured image based on the screen size of the first touch panel 12, and may generate the preview image PG2 by adjusting the display size of the captured image based on the screen size of the second touch panel 22. The second CPU 21 may cause the preview image PG1 to be displayed on the first touch panel 12 while simultaneously causing the preview image PG2 to be displayed on the second touch panel 22.

Accordingly, even when the screen sizes of the first touch panel 12 and the second touch panel 22 are different, the payment terminals 100 and 100A can display the preview images PG1 and PG2 in accordance with the screen sizes.

Further, the second CPU 21 may cause the preview image PG1 and the guidance information GI for guiding the arrangement method of the mobile terminal 200 with respect to the camera 25 to be simultaneously displayed on the first touch panel 12.

Accordingly, the customer can more easily recognize how to arrange the mobile terminal 200 with respect to the camera 25 to enable the code payment.

Although various embodiments have been described above with reference to the drawings, it is needless to say that the present invention is not limited to these embodiments. It is apparent that those skilled in the art can conceive of various modifications or corrections within the scope described in the claims, and it is understood that such modifications or corrections naturally fall within the technical scope of the present invention. In addition, the constituent elements in the above embodiments may be freely combined without departing from the scope of the invention.

It is illustrated in the above embodiments that the code CD used for the code payment is displayed on the mobile terminal 200, but the present invention is not limited thereto. A medium (for example, the paper medium) other than the mobile terminal 200 may be displayed. For example, code payment using a printed code is also possible. Also in this case, the payment terminals 100 and 100A can guide the code displayed on the medium to appropriate positions or distances with respect to the payment terminals 100 and 100A.

Further, the above embodiments are not limited to code reading for the code payment, and may be applied to other uses. For example, the above embodiments may be applied in order to arrange a point card or a passport on which the code CD is printed to an appropriate position or distance with respect to a reader including the camera 25. In addition, in the code reading performed by the camera 25, the above embodiments may be applied in order to arrange the passport or the like to an appropriate position or distance with respect to the reader when characters are optically read by optical character recognition (OCR) or the like.

Further, in the above embodiments, a program for implementing a function of a payment assistance method according to the above embodiments may be supplied to an information processing device (for example, the payment terminal) which is a computer via a network or various storage media, and a program that is read and executed by a processor of this information processing device and a recording medium in which this program is stored may be used as the application range.

In the above embodiments, the processor may be physically implemented in any manner. When a programmable processor is used, a processing content can be changed by changing a program, and thus a degree of freedom in designing the processor can be increased. The processor may be implemented by one semiconductor chip, and may be physically implemented by a plurality of semiconductor chips. In the case of the plurality of semiconductor chips, controls according to the above embodiments may be implemented by different semiconductor chips. In this case, it can be considered that one processor is implemented by the plurality of semiconductor chips. The processor may be implemented by a member (a capacitor or the like) having a function different from that of the semiconductor chip. One semiconductor chip may implement functions of the processor and other functions. A plurality of processors may be implemented by one processor.

The present disclosure is based on Japanese Patent Application No. 2022-198008 filed on Dec. 12, 2022, and the contents thereof are incorporated herein by reference.

### INDUSTRIAL APPLICABILITY

The present disclosure is useful for a payment terminal, a payment assistance method, and the like that are capable of easily guiding a position of a medium with respect to a camera that captures an image of a code displayed on the medium.

What is claimed is:

1. A payment terminal capable of performing payment using a code, the payment terminal comprising:
a first display unit;
a second display unit;
an imaging unit that is arranged near the first display unit and that captures an image of the code displayed on a medium; and
a control unit that controls the first display unit, the second display unit, and the imaging unit, wherein
the control unit
acquires a captured image captured by the imaging unit, and
causes a first preview image based on the captured image to be displayed on the first display unit while simultaneously causing a second preview image based on the captured image to be displayed on the second display unit.

2. The payment terminal according to claim 1, wherein
the payment terminal includes a first terminal and a second terminal,
the first terminal includes the first display unit and the imaging unit,
the second terminal includes the second display unit and the control unit, and
the control unit
acquires the captured image from the imaging unit of the first terminal,
compresses the captured image at a first compression rate to generate the first preview image,
compresses the captured image at a second compression rate different from the first compression rate or a second compression rate the same as the first compression rate to generate the second preview image, or generates the second preview image without compressing the captured image,
transfers the first preview image to the first display unit,
transfers the second preview image to the second display unit, and
causes the first preview image to be displayed on the first display unit while simultaneously causing the second preview image to be displayed on the second display unit.

3. The payment terminal according to claim 2, wherein
the control unit
acquires, as the captured image, a captured video including a plurality of images captured sequentially in time series by the imaging unit,
compresses the captured video at a third compression rate to generate a first preview video as the first preview image,
compresses the captured video at a fourth compression rate different from the third compression rate or a fourth compression rate the same as the third compression rate to generate a second preview video as the second preview image, or generates a second preview video as the second preview image without compressing the captured video,
transfers the first preview video to the first display unit,
transfers the second preview video to the second display unit, and
causes the first preview video to be displayed on the first display unit while simultaneously causing the second preview video to be displayed on the second display unit.

4. The payment terminal according to claim 1, wherein
a screen size of the first display unit is different from a screen size of the second display unit, and
the control unit
adjusts a display size of the captured image based on the screen size of the first display unit to generate the first preview image,
adjusts the display size of the captured image based on the screen size of the second display unit to generate the second preview image, and
causes the first preview image to be displayed on the first display unit while simultaneously causing the second preview image to be displayed on the second display unit.

5. The payment terminal according to claim 1, wherein
the control unit causes the first preview image and guidance information for guiding an arrangement method of the medium with respect to the payment terminal to be simultaneously displayed on the first display unit.

6. The payment terminal according to claim 1, wherein
the medium is a third terminal that displays the code.

7. The payment terminal according to claim 1, wherein
the payment terminal is a stationary terminal.

8. A payment assistance method for assisting payment using a code provided by a payment terminal, the payment terminal including a first display unit, a second display unit, and an imaging unit that is arranged near the first display unit and captures an image of the code displayed on a medium, the payment assistance method comprising:
acquiring a captured image captured by the imaging unit; and
displaying, on the first display unit, a first preview image based on the captured image 10 while simultaneously displaying, on the second display unit, a second preview image based on the captured image.
